(19) United States
(12) Patent Application Publication
(10) Pub. No.: US 2005/0231426 A1
(43) Pub. Date: Oct. 20, 2005

(54) Transparent wideband antenna system

(76) Inventor: Nathan Cohen, Belmont, MA (US)

Correspondence Address: MCDERMOTT WILL & EMERY LLP;ATTN: INTELLECTUAL PROPERTY DEPTARTMENT DOCKETING, 28 STATE STREET, BOSTON, MA, 02109, US

(21) Appl. No.: 11/049,231

(22) Filed: Feb. 2, 2005

Related U.S. Application Data
(60) Provisional application No. 60/541,191, filed on Feb. 2, 2004.

(51) Int. Cl. H01Q 9/16

(52) U.S. Cl. 343/700 MS; 343/793

(57) ABSTRACT

An antenna includes an electrically conductive conformal portion that is substantially defined by a triangular portion and self-similar extensions. The antenna also includes an electrically non-conductive conformal portion. Both the electrically conductive conformal portion and the electrically non-conductive portion are substantially transparent at visual wavelengths.

### RELATED APPLICATIONS

This application is related to the following U.S. application, of common assignee, from which priority is claimed, and the contents of which are incorporated herein in their entirety by reference: “Transparent Wideband Antenna,” U.S. Provisional Patent Application Ser. No. 60/541,191, filed Feb. 2, 2004. This application is also related to the following U.S. application, of common assignee, and the contents of which are incorporated herein in their entirety by reference: “Antenna System for Radio Frequency Identification,” U.S. patent application Ser. No. 10/971,815, filed Oct. 22, 2004.

### GOVERNMENT LICENSE RIGHTS

The U.S. Government has a paid-up license in this invention and the right in limited circumstances to require the patent owner to license others on reasonable terms as provided for by the terms of contract No. M67854-03-C-7022 awarded by the United States Marine Corps Systems Command (MARCORSYSCOM).

### TECHNICAL FIELD

This disclosure relates to antenna systems and, more particularly, to wideband antennas mounted on visually transparent material.

### BACKGROUND

Antennas are used to typically radiate and/or receive electromagnetic signals, preferably with antenna gain, directivity, and efficiency. Practical antenna design traditionally involves trade-offs between various parameters, including antenna gain, size, efficiency, and bandwidth.

Antenna design has historically been dominated by Euclidean geometry. In such designs, the closed area of the antenna is directly proportional to the antenna perimeter. For example, if one doubles the length of an Euclidean square (or “quad”) antenna, the enclosed area of the antenna quadruples. Classical antenna design has dealt with planes, circles, triangles, squares, ellipses, rectangles, hemispheres, paraboloids, and the like.

With respect to antennas, prior art design philosophy has been to pick a Euclidean geometric construction, e.g., a quad, and to explore its radiation characteristics, especially with emphasis on frequency resonance and power patterns. Unfortunately antenna design has concentrated on the ease of antenna construction, rather than on the underlying electromagnetics, which can cause a reduction in antenna performance.

Antenna systems that incorporate a Euclidean geometry include roof-mounted antennas that extend from objects such as residential homes or automobiles. However, such extendable antennas are susceptible to wind and other weather conditions. To reduce the effects of weather, an antenna may be mounted in a conformal fashion to a surface. For example, a conformal antenna may be mounted into the rear window of an automobile or into the side of a house. However, due to the metallic material that provides a conductive surface, these conformal antennas may be visually obstructive. For example, by mounting a series of metallic traces in a rear window of a car, the traces may obstruct the driver's view. Additionally, by implementing a Euclidean geometry into these conformal antennas, antenna performance is degraded.

### SUMMARY OF THE DISCLOSURE

In accordance with an aspect of the disclosure, an antenna includes an electrically conductive conformal portion that is substantially defined by a triangular portion and self-similar extensions. The antenna also includes an electrically non-conductive conformal portion. Both the electrically conductive conformal portion and the electrically non-conductive portion are substantially transparent at visual wavelengths.

In one embodiment, the self-similar extensions may include two or more angular bends. The antenna may also include a counterpoise to balance the electrically conductive conformal portion. The counterpoise may be defined substantially by a repetitive tooth-like pattern. The antenna is configured to transmit or receive electromagnetic energy between approximately 70 MHz and 3000 MHz. The electrically conductive portion may be coated with a substantially transparent material. The electrically conductive portion may be mounted to a substantially transparent substrate that includes polyethylene terephthalate (PET). The electrically non-conductive portion may be coated with a transparent laminate. The counterpoise may include conductive attachments.

In accordance with another aspect, an antenna system includes an antenna having an electrically conductive conformal portion defined substantially by a triangular portion and self-similar extensions. The antenna also an electrically non-conductive conformal portion and both conformal portions are substantially transparent at visual wavelengths. The antenna system also includes an electrical connector that is connected to the electrically conductive conformal portion of the antenna to transfer electromagnetic signals.

In one embodiment of the system, a conductive epoxy may connect the electrical connector to the electrically conductive conformal portion of the antenna. The system may also include a transceiver that is connected to the electrical connector. The transceiver includes a low noise amplifier and/or a power amplifier.

Additional advantages and aspects of the present disclosure will become readily apparent to those skilled in the art from the following detailed description, wherein embodiments of the present invention are shown and described, simply by way of illustration of the best mode contemplated for practicing the present invention. As will be described, the present disclosure is capable of other and different embodiments, and its several details are susceptible of modification in various obvious respects, all without departing from the spirit of the present disclosure. Accordingly, the drawings and description are to be regarded as illustrative in nature, and not as limitative.

### BRIEF DESCRIPTION OF THE DRAWINGS

FIG. 1 is a diagrammatic view of a visually-transparent conformal wideband antenna mounted to a window.

FIG. 2 is a diagrammatic view of a visually-transparent conformal wideband antenna connected to a transceiver.

### DETAILED DESCRIPTION OF THE EMBODIMENTS

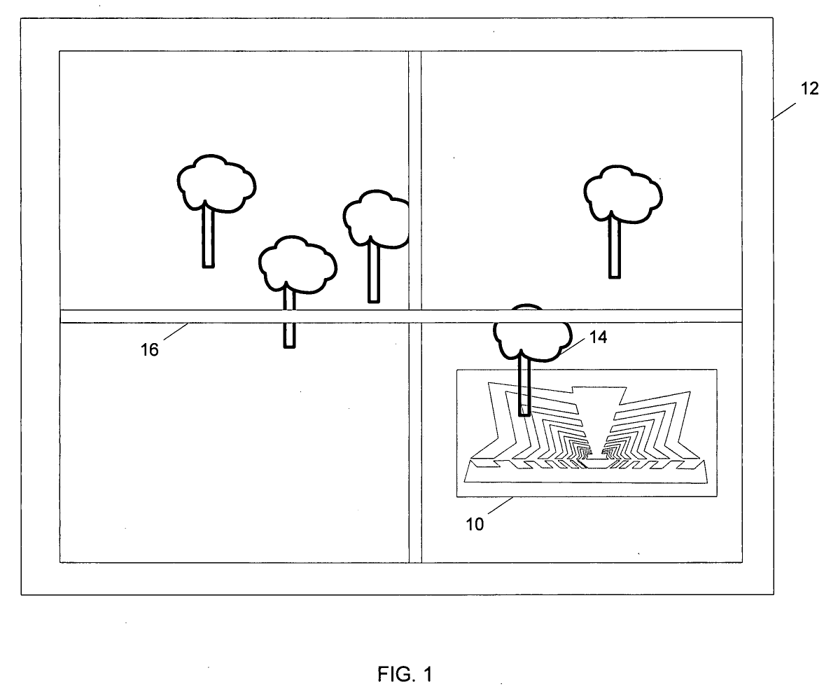

Referring to FIG. 1, an antenna 10 is mounted conformal to the transparent surface (e.g., glass, fiberglass, etc.) of a window 12. Due to materials and production procedures, antenna 10 is substantially transparent at wavelengths in the visual portion of the electromagnetic spectrum. For illustrative purposes, while the view of a portion of a tree 14 is obstructed by the frame 16 of window 12, the tree is not visually obstructed by antenna 10. To mount antenna 10 conformal to window 12, antenna 10 predominately extends in two dimensions (i.e., length and width) and is relatively thin to provide flexibility for mounting to the window surface. By providing a visually transparent antenna, a person's field of view through window 12 is not obstructed. In some arrangements, providing an unobstructed view may be crucial to a person. For example, if antenna 10 is mounted on the front or rear windshield of an automobile, the safety of the driver will improve since he or she will still have a clear view through the antenna for traffic in front or behind them.

Along with providing an unobstructed view, antenna 10 is designed with a self-similar geometry that provides broad frequency coverage for signal transmission or reception. In general the self-similar shape is defined as a fractal geometry. Fractal geometry may be grouped into random fractals, which are also termed chaotic or Brownian fractals and include a random noise components, or deterministic fractals. Fractals typically have a statistical self-similarity at all resolutions and are generated by an infinitely recursive process. For example, a so-called Koch fractal may be produced with N iterations (e.g., N=1, N=2, etc.). One or more other types of fractal geometries may also be incorporated into the design to produce antenna 10.

By incorporating the fractal geometry into the electrically conductive and non-conductive portions of antenna 10, the length and width of the conductive and non-conductive portions of the antenna is increased due to the nature of the fractal pattern. However, while the lengths and widths increase, the overall footprint area of antenna 10 is relatively small. By providing longer conductive paths, antenna 10 can perform over a broad frequency band. For example, the size reduction (relative to a wavelength) for the lowest frequency of operation approximately has a ratio of 15:1 to 20:1. In this arrangement, antenna 10 may perform at frequencies within a broad frequency band of 70 Mega Hertz (MHz) to 3000 MHz. However, it should be appreciated that performance within other frequency bands may be achieved. Thus, antenna 10 is capable of transmitting and receiving electromagnetic signals over a broader frequency range.

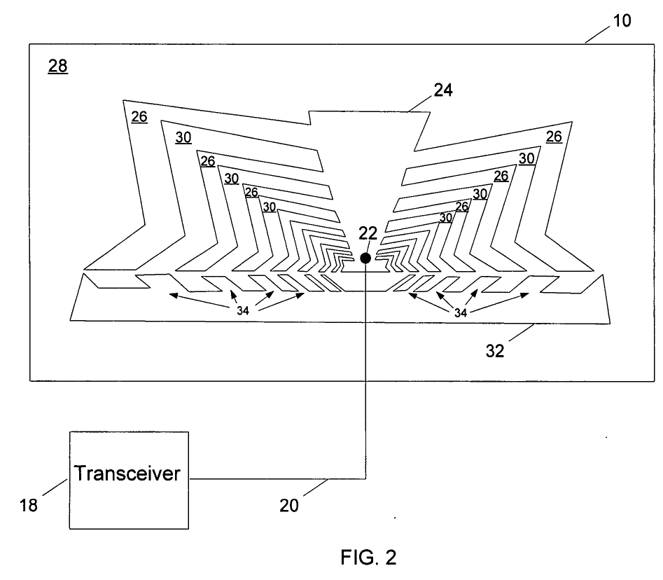

Referring to FIG. 2, antenna 10 is connected to a transceiver 18 over a conductor 20 (e.g., a cable, conducting trace, wire, etc.). By connecting to antenna 10, transceiver 18 may send signals to the antenna for transmission or receive signals collected by the antenna. Typically to send and receive signals (and improve the gain of antenna 10), transceiver 10 includes a low noise amplifier (LNA) and power amplifier (PA). To connect conductor 20 to antenna 10, a connector 22 is electrically connected to the conductor and the antenna. Various techniques known to one skilled in the art of electronics and antenna system design may be implemented to connect connector 22 to antenna 10. For example, an electrically conductive epoxy may be used to provide an adhesive connection with appropriate electrical conductivity.

In this exemplary fractal antenna design, antenna 10 includes an electrically conductive portion and a non-conductive portion. In particular, the electrically conductive portion incorporates a self-similar pattern (e.g., a fractal geometry) that includes a triangular section 24 and a series of self-similar extensions 26. Each of the extensions include multiple angular bends to incorporate the self-similar pattern. In this example, each extension includes at least two angular bends. However, in other embodiments more angular bends may be incorporated to produce a similar fractal geometry or a different type of self-similar pattern.

Various types of visually-transparent, conductive materials may be used to produce the electrically conductive portion (i.e., triangular section 24 and self-similar extensions 26) of antenna 10. For example, various types of metallic material such as metallic paint, metallic ink or powder, metallic film, or other similar materials capable of conducting electricity may be selected. In this particular example, the electrically conductive portion of antenna 10 is produced from an electrically conductive coating that covers a visually-transparent, non-conductive substrate. To produce the shape of triangular section 24 and self-similar extensions 26, a laser is used to ablate the conductive coating and from the non-conductive substrate.

By exposing portions of the visually transparent non-conductive substrate, a boundary of triangular section 24 and the outer-most self-similar extensions is defined by a portion 28 of the substrate. Additionally, exposed segments 30 of the substrate define boundaries of the self-similar extensions 26. Various types of visually-transparent, non-conductive materials may be used as a substrate to define the boundaries of the conductive portions of antenna 10. For example, these materials may include insulators (e.g., air, etc.), dielectrics (e.g., glass, fiberglass, plastics, etc.), semiconductors, and other materials that impede the flow of electricity and are visually transparent or semi-transparent.

In some embodiments, the non-conductive portions (i.e., portion 28 and segments 30) of antenna 10 are produced from a high quality plastic such as polyethylene terephthalate (PET) that is visually transparent, light weight, structurally sturdy, and may be processed (e.g., shaped) relatively quickly. Along with impeding current flow, the non-conductive material also typically provides structural support to the conductive portion of antenna 10. To provide such support, the non-conductive materials may include materials typically used for support that are also visually transparent (e.g., plastic, etc.). To protect antenna 10 (and provide structural support), a visually transparent (or semi-transparent) material may cover the conductive and non-conductive portions of the antenna. For example, both sides of antenna 10 may be covered by a transparent laminate that is applied with a thermal transfer. The electrically conductive portion and the non-conductive may also be cover by similar or dissimilar material. For example, one laminate may be used to cover the conductive portion of antenna 10 while another laminate is used to cover the non-conductive portion. These different laminates may be used to approximately match the optical appearance of both portions. Multiple layers of materials may also be used to cover the portions of antenna 10. For example, one layer of laminate may be applied to the electrically-conductive portions of antenna 10 and two or more layers of laminate may be applied to the non-conductive portions to match the optical appearances of the entire antenna.

In this exemplary design, the electrically conductive portion of antenna 10 also includes a counterpoise 32 that balances the electromagnetic signal transmission and/or reception by triangular section 24 and self-similar extensions 26. In this example, counterpoise 32, which is also visually transparent (or semi transparent), includes a series of tooth-like extensions 34. To expand the frequency coverage of antenna 10, additional structure may be included in the antenna. For example, one or more conductors (e.g., conductive traces, wires, etc.) may be attached to some (or all) of the tooth-like extensions 34. By including these conductive attachments, the frequency coverage of antenna may be significantly extended. For example, for this exemplary design, the frequency coverage may extend below 70 MHz by connecting conductive attachments on counterpoise 32.

Antenna 10 may be implemented into various types of antenna systems known to one skilled in the art of antenna design and antenna system design. For example, antenna 10 may be adhesively attached to a window pane (e.g., such as window 12) of a house or other similar structure (e.g., a commercial building, retail store, etc.) to transmit and/or receive electromagnetic signals. In one scenario, antenna 10 may be used to transfer radio frequency (RF) signals among telephones (e.g., wireless telephones, cellular telephones, etc.) located within the house with telecommunication equipment (e.g., a cellular phone tower, satellite, etc.) external to the house. In another scenario, antenna 10 may be mounted between glass panes (or on a glass pane) of an automobile windshield. By providing a visually transparent antenna, a driver's field of view is not obstructed by the antenna. Furthermore, by the incorporating a self-similar geometry into the visually-transparent antenna, a wide frequency band coverage is provided by the antenna for the transmission or reception of electromagnetic signals.

Along with wideband frequency coverage for broadband operations, by incorporating a fractal geometry into antenna 10 to increase conductive trace length and width, antenna losses are reduced. By reducing antenna loss, the output impedance of antenna 10 is held to a nearly constant value across the operating range of the antenna. For example, a 50-ohm output impedance may be provided by antenna 10 across the operational frequency band.

A number of implementations have been described. Nevertheless, it will be understood that various modifications may be made. Accordingly, other implementations are within the scope of the following claims.

1. An antenna comprising:
an electrically conductive conformal portion defined substantially by a triangular portion and self-similar extensions; and
an electrically non-conductive conformal portion; wherein the electrically conductive conformal portion and the electrically non-conductive portion are substantially transparent at visual wavelengths.

2. The antenna of claim 1, wherein the self-similar extensions include two or more angular bends.

3. The antenna of claim 1, further comprising:
a counterpoise to balance the electrically conductive conformal portion.

4. The antenna of claim 1, further comprising:
a counterpoise is defined substantially by a repetitive tooth-like pattern.

5. The antenna of claim 1, wherein the antenna is configured to transmit electromagnetic energy between approximately 70 MHz and 3000 MHz.

6. The antenna of claim 1, wherein the antenna is configured to receive electromagnetic energy between approximately 70 MHz and 3000 MHz.

7. The antenna of claim 1, wherein the electrically conductive portion is coated with a substantially transparent material.

8. The antenna of claim 1, wherein the electrically conductive portion is mounted to a substantially transparent substrate that includes polyethylene terephthalate (PET).

9. The antenna of claim 1, wherein the electrically non-conductive portion is coated with a transparent laminate.

10. The antenna of claim 4, wherein the counterpoise includes conductive attachments.

11. An antenna system comprising:
an antenna including,
a electrically conductive conformal portion defined substantially by a triangular portion and self-similar extensions, and
an electrically non-conductive conformal portion; wherein the electrically conductive conformal portion and the electrically non-conductive portion are substantially transparent at visual wavelengths; and
an electrical connector connected to the electrically conductive conformal portion of the antenna to transfer electromagnetic signals.

12. The antenna system of claim 11, wherein a conductive epoxy connects the electrical connector to the electrically conductive conformal portion of the antenna.

13. The antenna system of claim 11, further comprising:
a transceiver is connected to the electrical connector.

14. The antenna system of claim 13, wherein the transceiver includes a low noise amplifier.

15. The antenna system of claim 13, wherein the transceiver includes a power amplifier.
